(19) United States
(12) Patent Application Publication
(10) Pub. No.: US 2015/0047716 A1
(43) Pub. Date: Feb. 19, 2015

(54) VENT VALVE

(71) Applicant: P.I.H.A. Pty Ltd, Applecross, Western Australia (AU)

(72) Inventors: Jeffrey Muir, Perth (AU); Aaron John Roy Goodwin, Perth (AU)

(73) Assignee: P.I.H.A. Pty Ltd, Applecross, Western Australia (AU)

(21) Appl. No.: 14/386,655

(22) PCT Filed: Mar. 20, 2013
(86) PCT No.: PCT/AU2013/000280

§ 371 Date: Sep. 19, 2014

(30) Foreign Application Priority Data
Mar. 20, 2012 (AU) 2012901126

(51) Int. Cl. F16K 24/04; F16L 55/07

(52) U.S. Cl. CPC F16K 24/048; F16L 55/07
USPC 137/202; 137/199

(57) ABSTRACT

A pipeline vent valve is disclosed having a housing that includes an upper portion defining an outlet and a lower end defining an inlet. A body disposed in the housing is movable between a first position and a second position. In the second position, the body affects the close of the outlet and the outlet is offset from a longitudinal axis of the body. A valve assembly is supported by an upper end of the housing and is movable between a closed position where the valve assembly is disposed in sealing engagement with the outlet and an open position where the valve assembly is out of sealing engagement with the outlet. The valve assembly is responsive to a level of fluid in the housing and includes an arm that is pivotally secured adjacent the outlet for movement in only one plane relative to the outlet.

### FIELD OF THE INVENTION

This invention relates to vent valves which are utilised in pipelines for releasing air and other gases from the pipeline. This prevents the formation of air pockets within the pipeline which would otherwise restrict the flow of fluid through the pipeline, affecting the efficiency of the pipeline and pumping system.

### BACKGROUND ART

Air release valves are well known in various industries. One type of valve is secured to a pipeline to vent any gas which accumulates under-pressure during normal operating conditions. This type of valve comprises a float member which is located in a housing. The housing has a venting aperture at its upper end, while a lower end is adapted to be mounted to a pipeline.

During normal operation of the valve, fluid enters the housing which buoys the float member upwardly to seal the outlet aperture. As gas migrates into the housing from the pipeline, fluid is displaced from the housing. When sufficient gas has migrated into the housing the float member is caused to move downwardly thereby opening the outlet aperture and allowing the gas to vent from the housing. When sufficient gas has vented, the float member returns to a position which blocks the outlet aperture. This cycle continues based on the rate of gas migration from the pipeline into the housing.

in this type of valve the float is typically associated with a bearing member, which moves as a result of movement of the float. The bearing member acts upon a valve member to open and close the aperture. As a result it is critical that the valve member aligns correctly with the aperture and engages with the aperture with sufficient force to ensure sealing of the valve. Currently, to ensure the valve member correctly aligns with the aperture the valve needs to be tested, and if the aperture does not properly seal, the valve needs to be disassembled, adjusted and reassembled before being tested again. This is a tedious task and usually takes a skilled operator three or more adjustments before the valve is correctly set. The multiple assembling and disassembling of the valve to make the adjustment also wears the components of the vent valve, potentially reducing the life of the valve.

Another problem associated with current vent valves is that they are constantly venting and closing in rapid succession, or they remain open and vent constantly, suggesting that the gas is not able to completely vent. This is caused by the vent valve having a relatively small vent aperture, typically 1.5 mm. In these valves the float acts directly to close and open the vent aperture. If the aperture was bigger atmospheric pressure would adversely affect the operation of the valve.

Also, in those valves having a float exposed to atmosphere, high pressure and/or high velocity in the pipeline creates a pressure differential across the float which will keep the float in an uppermost position, keeping the aperture closed and preventing the discharge of gas through the valve.

Vent valves are used in pipelines across a number of industries, including the coal seam gas industry. In these applications it is essential that, the valves are able to withstand fire should one occur in the vicinity of the pipeline. Currently vent valves are made from a combination of metal and polymer based materials which can melt, rendering the valve in effective, and may also allow the pipeline to leak.

The preceding discussion of the background art is intended to facilitate an understanding of the present invention only. The discussion is not an acknowledgement or admission that any of the material referred to is or was part of the common general knowledge as at the priority date of the application.

AMENDED SHEET

### DISCLOSURE OF THE INVENTION

It is an object of the present invention to overcome at least some of the problems referred to above or at least reduce the likelihood of at least one of the difficulties referred to above arising.

Accordingly, the invention further resides in a vent valve comprising:

a housing for housing a body movable between a first position and a second position, the body being adapted to close an outlet when the body is in the second position, the housing adapted to be in fluid communication with a pipeline, the housing having an inlet towards its lower end, and the outlet in an upper portion, the outlet being offset from a longitudinal axis of the body;

a valve assembly supported in the upper portion of the housing to be movable between a closed position, in which it is in sealing engagement with the outlet, and an open position, in which it is out of sealing engagement with the outlet, the valve assembly being responsive to the level of liquid in the housing.

The present invention further resides in a vent valve comprising:

a housing, housing a body movable between a first position and a second position, the body being adapted to affect the close of an outlet in an upper end of the housing when the body is in the second position, the housing adapted to be in fluid communication with a pipeline, the housing having an inlet towards its lower end, and the outlet being offset from a longitudinal axis of the body;

a valve assembly supported by the upper end of the housing, including a securing means, and an arm to be movable between a closed position, in which the valve assembly is in sealing engagement with the outlet, and an open position, in which the valve assembly is out of sealing engagement with the outlet, the valve assembly being responsive to the level of liquid in the housing; and

wherein the securing means is attached to the upper end and includes an arm receiving recess secured to the arm, the profile of the arm receiving recess being such that the arm is restricted to move in only one plane relative to the outlet.

Preferably the valve assembly comprises an arm wherein the arm is secured such that it is substantially restricted to move in only one plane relative to the outlet.

In contrast to the prior art the configuration of the valve assembly provides more accurate seating of the arm in the closed position, negating the need to undergo multiple tests and re-adjustments to ensure the vent valve operates in the desired manner. In addition the valve assembly improves the sealing of the outlet. Also as the float does not act directly upon the outlet it is not exposed to atmosphere, ensuring the operation of the vent valve is independent of atmospheric conditions.

Preferably when the body is in the first position the outlet is closed and fluid and gas is able to migrate into the housing. Preferably when the body is in the first position the body is in its upper most position, as may be constrained by the configuration of the vent valve.

Preferably the body is in the form of a float.

The float may cause the movement of the valve assembly between the closed and open positions as a result of the change in fluid level in the housing.

The housing may be in the or of a cylinder having an upper cap and a lower cap

The valve assembly may further comprise a post. The post may be secured to the planar surface of the upper cap. The post may have two screws which fasten the post to the upper cap. The post may be secured to the upper cap at a position adjacent the outlet which is located therein.

The post may have two extending supports between which the arm is pivotally retained. The arm may be retained at a first end thereof. A pin may pass through the first support, through the first end of the arm and through the second support. With this arrangement the arm is restricted to move in a plane substantially orthogonal to the upper cap.

The arm may incorporate a sealing means to seal the outlet when in the closed position. The sealing, means may be located adjacent the first end. The sealing means may be in the form of a resilient material vulcanised or otherwise attached to the arm.

A portion at the second end of the arm may be adapted to engage the float. The portion may be adapted to support a bobbin wherein the bobbin engages the float as the float moves upwardly.

The portion of the arm at the second end may incorporate a slot in which the bobbin is variably supported.

Preferably the outlet allows for large venting capacity. Preferably the diameter of the outlet is greater than 5 mm. Preferably the diameter of the outlet is in the range of 7 mm to 9 mm.

Preferably the levering configuration of the valve assembly provides the arm with a 6:1 mechanical advantage. This results in an increased force per unit area of the sealing means on the outlet, thereby reducing the chance of leaks during periods of low pressure transients. Valves that use direct acting floats (Le. floats that engage the outlet to close the outlet) tend to leak at low pressure when associated with a large outlet as there is less force per unit area applied by the float on the outlet.

Preferably the float is isolated from atmosphere. Preferably the fluid in the housing, and/or the gas which accumulates in the upper part of the housing surrounds the float such that the only pressure exerted upon the float is that of the gas and/or fluid. In the vent valve of the present invention, the float is isolated from the atmosphere by the valve assembly. In operation, the float is exposed to the pressure exerted by the fluid in the housing as well as any gas—both of which are at high pressure. As the gas increases in volume due to more gas entering the vent valve from the pipeline, the level of liquid drops, causing the float to move downwardly. When the float has dropped sufficiently the valve assembly also moves causing the outlet to be open. As the gas in the housing is at a higher pressure than atmosphere, the gas will automatically vent from the valve until such time as the volume of gas in the housing decreases, allowing the level of liquid to rise, the float to rise and eventually the outlet to be blocked by the valve assembly, preventing further venting, preventing the entry of gas from the atmosphere. In operation, as the pressure in the vent valve is always higher than atmosphere, movement of fluid/gas through the outlet is restricted to movement from the housing to atmosphere. Atmospheric pressure has no effect on the operation of the vent valve. As the float is isolated from atmospheric pressure there is no premature closing of the vent valve as a result of pipeline pressure or large outflow velocity. Where the float is subjected to atmospheric pressure, a pressure differential occurs across the float leading to the float closing the outlet when operating at high pressure, thus preventing venting.

The end cap may have a recess therein for receiving an upper end of the bobbin. This allows the arm to move sufficiently upward to adequately seal the outlet when in the closed position. The recess may be self-centring to increase the stability of the valve assembly when received the bobbin is received therein.

Preferably the valve assembly moves to its closed position upon the liquid level in the housing exceeding a predetermined level.

Preferably the vent valve is configured to be a one way valve, whereby gas may only vent through the outlet. The vent valve may be configured to be a single outlet, one way valve having a large autoventing capacity. If air was able to flow back into the valve there is the possibility of creating explosive conditions within the pipeline. The float may be adapted to engage a seal on the lower cap of the housing to prevent fluid or gas entering the housing from the inlet.

The vent valve may be fire resistant. The vent valve may be made of metal, such as stainless steel.

The float member and the valve housing may be separate.

The vent valve may be configured such that the fluid level in the housing does not approach the outlet. This prevents the possibility of any fluid being discharged through the outlet. This negates the need to have an exhaust riser located above the outlet.

The present invention further resides in a pipeline vent valve comprising a housing, the housing adapted to be connected to a pipeline to be in fluid communication therewith, the housing having an inlet towards its lower end, and an outlet in an upper portion, a valve assembly supported in the upper portion of the housing to be movable between a closed position at which it is in sealing engagement with the outlet and an open position in which it is out of sealing engagement with the outlet, the valve assembly being responsive to the level of liquid in the housing, the vent valve being made from fire resistant material.

The present invention further resides in a pipeline vent valve comprising a housing, the housing adapted to be connected to a pipeline to be in fluid communication therewith, the housing having an inlet towards its lower end, and an outlet in an upper portion, a valve assembly supported in the upper portion of the housing to be movable between a closed position at which it is in sealing engagement with the outlet and an open position in which it is out of sealing engagement with the outlet, the valve assembly being responsive to the level of liquid in the housing, wherein the valve assembly is secured to a planar surface of an upper cap of the housing so as to enable accurate assembly of the vent valve whereby the valve assembly is able to accurately seal the outlet and improve the operation of the vent valve.

Preferably the vent valve is rated to 1600 kPa.

Accordingly, the invention resides in a vent valve comprising:

a housing adapted to be in fluid communication with a pipeline, the housing having an inlet towards its lower end, and an outlet in an upper portion, the outlet being offset from a longitudinal axis of the housing;

a valve assembly supported in the upper portion of the housing to be movable between a closed position, in which it is in sealing engagement with the outlet, and an open position, in which it is out of sealing engagement with the outlet, the valve assembly being responsive to the level of liquid in the housing.

Preferably the valve assembly comprises a body movable between a first position and a second position, the body being adapted to close the outlet when the body is in the second position.

Preferably the valve assembly comprises an arm wherein the arm is secured such that it is substantially restricted to move in only one plane relative to the outlet.

The present invention further resides in a vent valve comprising:

a housing, housing a body movable between a first position and a second position, the body being adapted to affect the close of an outlet when the body is in the second position, the housing adapted to be in fluid communication with a pipeline, the housing having an upper end and a lower end, an inlet towards its lower end, passing through the lower end, and the outlet in an upper portion, passing through the upper end, the outlet being offset from a longitudinal axis of the body;

a valve assembly engaged to the upper end of the housing with an engaging means to be movable between a closed position, in which it is in sealing engagement with the outlet, and an open position, in which it is out of sealing engagement with the outlet, the valve assembly being responsive to the level of liquid in the housing;

wherein the valve assembly includes a bobbin adapted to engage the body; and

wherein the upper end includes a recess adapted to receive at least a portion of the bobbin to affect the dosing of the outlet .

The present invention further resides in a vent valve comprising:

a housing, housing a body movable between a first position and a second position, the body being adapted to affect the close of an outlet in an upper end of the housing when the body is in the second position, the housing adapted to be in fluid communication with a pipeline, the housing having an inlet towards its lower end, and the outlet being offset from a longitudinal axis of the body;

a valve assembly supported by the upper end of the housing, to be movable between a closed position, in which the valve assembly is in sealing engagement with the outlet, and an open position, in which the valve assembly is out of sealing engagement with the outlet, the valve assembly being responsive to the level of liquid in the housing; and

wherein the closed position is affected when the body is in the second position; and wherein the body only acts on the valve assembly when moving from the first to the second position, movement of the valve assembly from the second to the first position being affected by gravity.

The invention further resides in a vent valve comprising:

a housing comprising a cylinder having an upper cap at one end, and a lower cap at an other end, the upper cap has an outlet offset from a longitudinal axis of the valve, the lower cap having an inlet;

a body slidingly received in the housing, the body being responsive to the level of liquid in the housing;

a valve assembly secured to the underside of the upper cap, the valve assembly comprises an arm which is movable between a first position wherein the valve is in an open position, and a second position wherein the body causes the arm to seal the outlet such that the valve is in a closed position,

wherein the arm has a first end which is constrained to be pivotally secured to the upper end of the housing at a point adjacent the outlet to rotate about that point, the arm is pivotally secured such that the arm is restricted to move in only one plane relative to the outlet.

The invention will be more fully understood in light of the following description of several specific embodiments.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a cross sectional side view of a vent valve in an open condition according to an embodiment of the present invention;

FIG. 2 is a bottom view of an end cap of the vent valve of FIG. 1 showing the valve assembly;

FIG. 3 is a side view of FIG. 2, additionally showing a portion of a float;

FIG. 4 is a plan view of a post of the valve assembly shown in FIG. 2;

FIG. 5 is a plan view of an arm of the valve assembly shown in FIG. 2; and

FIG. 6 is a side view of FIG. 5.

In the drawings like structures are referred to by like numerals throughout the several views. The drawings shown are not necessarily to scale, with emphasis instead generally being placed upon illustrating the principles of the present invention.

### DETAILED DESCRIPTION OF SPECIFIC EMBODIMENTS

In particular the invention relates to a vent valve designed to automatically vent air/gas that accumulates within the valve's housing over time when the pipeline is running and pressurised. The valve is typically located at high points along a pipeline where gas accumulates, and is often referred to as a high point vent valve.

The embodiment is directed to a vent valve 11 which can be utilised in a pipeline (not shown) to enable air or gases contained within the pipeline to be autavented from the pipeline in a manner which allows the air/gas to be vented very quickly.

The vent valve 11 according to the embodiment also provides an arrangement whereby the sealing action of the vent valve is more consistent and reliable, requiring minimal or no adjustment once assembled.

As shown in the figures, the vent valve 11 comprises a housing 13 having an upper cap 15 at an upper end, and a lower cap 17 at a lower end.

The lower cap 17 is adapted to be secured to a pipeline so as to be in fluid communication with the pipeline, such that an inlet 19 allows fluid and gas to move between the pipeline and the vent valve 11.

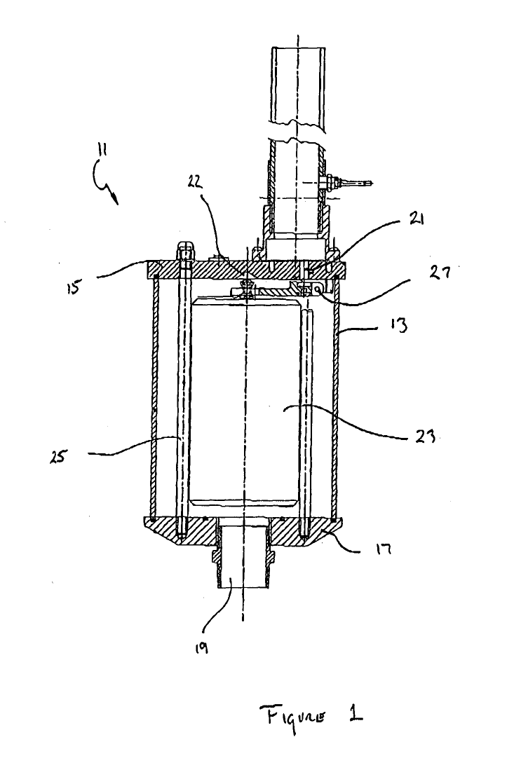

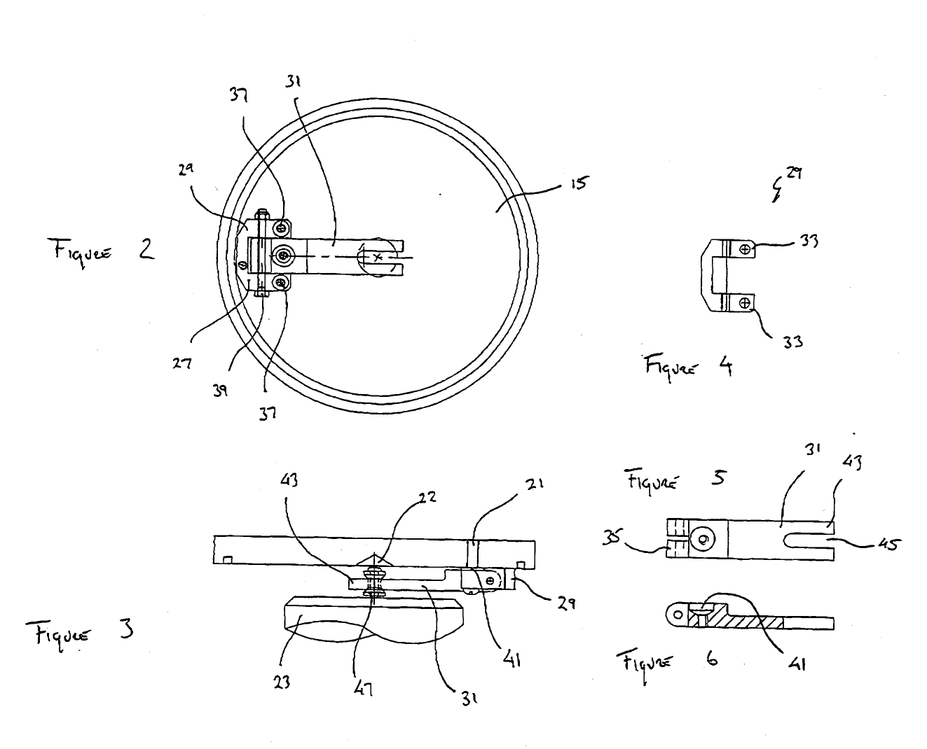

The upper cap 15 incorporates an outlet in the form of a venting aperture 21 which is in fluid communication with the atmosphere. The aperture 21 allows for the movement of air between the pipeline and the vent valve 11. As shown in FIG. 1, the aperture 21 is located in an off centre position.

The upper cap 15 also comprises a central recess 22 for reasons which are discussed below.

The housing 11 slidably supports a body in the form of a float 23 by means of a set of parallel guide rods 25 to facilitate slidable movement such that it is constrained to move along the longitudinal central axis of the housing 11.

The vent valve 11 also comprises a valve assembly 27 which is secured to the upper cap 15 as best shown in FIGS. 2 and 3. The valve assembly is movable between a closed position whereby the vent valve 11 is closed and no gas or fluid may move through the aperture 21, and an open position whereby the aperture 21 is open.

The valve assembly 27 comprises a post 29 and an arm 31.

The post 29 is adapted to be secured directly to the planar surface of the upper cap 15, at a position adjacent the aperture 21. As shown in FIG. 2 the post is secured to the upper cap 15 by screws 37 which pass through the post and into the upper cap. Other means of securing the post to the upper cap as would be obvious to a person skilled in the art may be used in place of screws without going outside the scope of this invention.

The post 29 comprises two projections 33 between which a first end 35 of the arm is received. As shown in FIG. 2 the arm 33 is pivotally secured to the post 29 by a pin 39 which passes through one of the projections 33, through the arm and through the remaining projection. With this arrangement the arm is restricted in movement relative to the upper cap 15 to a plane which is substantially orthogonal thereto. The arm is also adapted to fit between the projections in a manner which substantially reduces movement of the arm in any other direction.

The arm 31 incorporates a sealing, means 41 adjacent the first end 35. A portion adjacent a second end 43 of the arm 31 incorporates a slot 45 as shown in FIG. 5. The slot is adapted to receive a bobbin 47 so as to be adjustably positioned along the slot 45.

Once connected to a pipeline the vent valve 11 will automatically vent gases there from once the vent valve opens. In operation, fluid enters the housing 13 through inlet 19. The increasing fluid level causes the float 23 to rise. As the level of the fluid in the housing 13 rises, the float 23 is caused to engage the bobbin 47 forcing it upward. As the float and bobbin continue to move upwardly the arm 31 is caused to pivot towards the closed position in which the sealing means 41 covers and blocks the aperture 21. The top portion of the bobbin 47 is received in the recess 22, assisting in sealing the aperture 21.

When the vent valve is open, the rising level of the liquid causes any gas in the upper region of the housing to be expelled through the aperture 21. Once the aperture is closed no more gas is able to exit the housing 23 though the aperture 21.

As more gas migrates into the housing 13, the increase in gas causes the level of the liquid to lower. Eventually the liquid has dropped below a predetermined level, allowing the float 23 to move downwardly. This removes the force acting upon the arm 31, allowing the valve assembly to move to the open condition. The arm 31 pivots downwardly, disengaging the sealing means 41 from the aperture 21, allowing gas in the housing 13 to be vented through aperture 21.

As the aperture is offset from the longitudinal axis of the float, the float is not exposed to atmospheric conditions and can therefore provide an autoventing function independent of atmosphere. This also allows the size of the aperture to be relatively larger than with prior art, single aperture valves. As the orifice is larger, gas may be vented from the valve rapidly, ensuring the gas is vented before the liquid level increases to close the valve.

The robust nature of the valve assembly 27 and the manner in which it is secured to the upper cap 15 ensures the sealing means 41 reliably seals the aperture 21. Furthermore, the configuration of the valve assembly enables it to be accurate secured to the upper cap, increasing the reliability of the vent valve 11. It also improves manufacture of the vent valve as only minimal adjustments are required in order to ensure proper sealing of the aperture 21.

Also, as the valve assembly incorporates a levering action to seal the aperture, the aperture can be larger without compromising the sealing action. Direct acting floats are unable to provide sufficient force to adequately seal an aperture, particularly larger apertures.

The vent valve components are made from stainless steel. This ensures the vent valves 11 remain intact should they be exposed to excessive heat, as may be expected in a fire.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiments described above.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein

Reference to positional descriptions, such as lower and upper, are to be taken in context of the embodiments depicted in the figures, and are not to be taken as limiting the invention to the literal interpretation of the term but rather as would be understood by the skilled addressee

1-31. (canceled)

32. A vent valve comprising:
a housing comprising a cylinder having an upper cap at one end and a lower cap at another end, the upper cap having an outlet offset from a longitudinal axis of the vent valve, the lower cap having an inlet;
a body slidingly received in the housing, the body being responsive to a level of liquid in the housing;
a valve assembly secured to the underside of the upper cap, the valve assembly comprises an arm that is movable between a first position wherein the valve is in an open position and a second position wherein the body causes the arm to seal the outlet such that the valve is in a closed position;
wherein the arm is restricted to move in only one plane relative to the outlet; and
wherein the arm has a first end that is pivotally secured to the upper end of the housing adjacent the outlet to constrain movement of the first end of the arm to be pivotal thereabout.

33. A vent valve comprising:
a housing for housing a body which is movable between a first position and a second position, the body operably affecting the close of an outlet disposed in an upper portion of the housing when the body is in the second position, the housing being disposed in fluid communication with a pipeline, the housing having an inlet in its lower end, the outlet being offset from a longitudinal axis of the body;
a valve assembly supported by an upper end of the housing, the valve assembly being movable between a closed position wherein the valve assembly is in sealing engagement with the outlet and an open position wherein the valve assembly is out of sealing engagement with the outlet, the valve assembly being responsive to a level of fluid in the housing; and
wherein the valve assembly comprises an arm having a first end that is constrained to be pivotally secured adjacent the outlet, the arm being pivotally secured such that the arm is restricted to move in only one plane relative to the outlet.

34. The vent valve according to claim 33, wherein the outlet is closed and fluid and gas are able to migrate into the housing when the body is in the first position.

35. The vent valve according to claim 33, wherein the body is a float that causes the movement of the valve assembly between the closed position and open position as a result of a change in the level of fluid in the housing.

36. The vent valve according to claim 35, wherein a portion at the second end of the arm is adapted to engage the float.

37. The vent valve according to claim 36, wherein the portion supports a bobbin that engages the float as the float moves upwardly, the portion having a slot in which the bobbin is variably supported.

38. The vent valve according to claim 37, wherein the upper cap has a recess therein for receiving an upper end of the bobbin.

39. The vent vent valve according to claim 35, wherein at least one of the fluid and gas in the housing accumulates in the upper part of the housing and surrounds the float such that the only pressure exerted upon the float is that of at least one of the gas and fluid.

40. The vent valve according to claim 33, wherein the housing is a cylinder having an upper cap incorporating the outlet and a lower cap incorporating the inlet.

41. The vent valve according to claim 33, wherein the valve assembly further comprises a post, the post being secured to a planar surface of the upper cap.

42. The vent valve according to claim 41, wherein the post is secured to the upper cap at a position adjacent the outlet and wherein the post has two extending supports between which the arm is pivotally constrained, the arm being retained at the first end thereof by a pin, the pin passing through the first support, through the first end of the arm, and through the second support such that the arm is restricted to move in a plane substantially orthogonal to the upper cap.

43. The vent valve according to claim 33, wherein the arm incorporates a sealing member that seals the outlet when the valve is in the closed position, the sealing member being made of a resilient material that is vulcanized and attached to the arm.

44. The vent valve according to claim 33, wherein the outlet allows for a large venting capacity, the diameter of the outlet being greater than 5 mm.

45. The valve according to claim 33, wherein the arm of the valve assembly provides a levering configuration with a 6:1mechanical advantage.

46. The vent valve according to claim 33, wherein the valve assembly moves to its closed position in response to the level of fluid in the housing exceeding a predetermined level.

47. The vent valve according to claim 33, wherein the vent valve is a one way valve such that gas only vents through the outlet.

48. The vent valve according to claim 33, wherein the vent valve is fire resistant.

49. The vent valve according to claim 33, wherein the vent valve is rated to 1600 kPa.

50. The vent valve according to claim 33, wherein the valve assembly includes a bobbin that engages the body and wherein the upper end includes a recess adapted to receive at least a portion of the bobbin to affect the closing of the outlet.

51. The vent valve according to claim 33, wherein the closed position is affected when the body is in the second position and wherein the body only acts on the valve assembly when moving from the first position to the second position, movement of the valve assembly from the second position to the first position being affected by a weight of the valve assembly under gravity.

52. A pipeline vent valve comprising:
a housing connected to and disposed in fluid communication with a pipeline, the housing having an inlet in its lower portion and an outlet in an upper portion;
a valve assembly supported in the upper portion of the housing that is movable between a closed position where the valve assembly is disposed in sealing engagement with the outlet and an open position where the valve assembly is out of sealing engagement with the outlet, the valve assembly being responsive to a level of liquid in the housing; wherein the housing and valve assembly are made from fire resistant material; wherein the valve assembly includes an arm having a first end that is constrained to be pivotally secured at a point adjacent the outlet to rotate about that point, the arm being pivotally secured such that the arm is restricted to move in only one plane relative to the outlet; and wherein the valve assembly is secured to a planar surface of an upper cap of the housing so as to enable accurate assembly whereby the valve assembly operably seals the outlet with improved operation.

53. The vent valve according to claim 52, wherein the outlet is offset from a longitudinal axis of the housing.
